(19) United States
(12) Patent Application Publication
(10) Pub. No.: US 2026/0207979 A1
(43) Pub. Date: Jul. 23, 2026

(54) SELF-CONTAINED SYSTEM FOR DEFENSE AGAINST WILDFIRE-INDUCED DAMAGE TO STRUCTURES

(71) Applicant: Galapas Enterprises, LLC, Peachtree Corners, GA (US)

(72) Inventors: Nael A. McCarty, Peachtree Corners, GA (US); Stephen L. Peet, Peachtree Corners, GA (US); Sterling Peet, Atlanta, GA (US)

(73) Assignee: Galapas Enterprises, LLC, Peachtree Corners, GA (US)

(21) Appl. No.: 19/453,553

(22) Filed: Jan. 20, 2026

Related U.S. Application Data
(60) Provisional application No. 63/748,961, filed on Jan. 23, 2025.

(51) Int. Cl. A62C 3/02; A62C 5/02; A62C 35/02

(52) U.S. Cl. CPC A62C 3/0214; A62C 5/022; A62C 35/026

(57) ABSTRACT

Systems and methods for generating and distributing fire-retardant across specific surfaces of a structure (e.g., house, townhome, multi-family dwelling, etc.) in order to increase resistance to ignition in the case of wildfire may be activated by timer after the occupants of the structure have evacuated, and can be set to re-cycle to enable multiple treatments of the structure in case of delay of arrival of first-responders. The system also can be activated remotely. The self-contained nature of these designs enables the systems to be operated effectively without need for access to municipal water supply or electricity supply, both of which can be unreliable during a firestorm.

### CROSS-REFERENCE TO RELATED APPLICATIONS

This application claims the benefit of U.S. Provisional Application No. 63/748,961 filed Jan. 23, 2025. The entirety of this application is hereby incorporated by reference for all purposes.

### BACKGROUND

Recent years have seen a great increase in the frequency and severity of damage to homes and other structures due to wildfire. The increase largely has been driven by the confluence of two ongoing circumstances. First, as population density increases in urban settings across the world, more and more residences are being built adjacent to forest and other wildland in what is known as the “wildland-urban interface” (WUI). Second, as climate change ensues, many urban areas are experiencing less predictable weather patterns whereby in some years a higher-than-normal wet season leading to extensive growth in forest understory is followed by drought, such that the recent growth becomes highly flammable tinder. An example is the 2025 Palisades Fire in the Pacific Palisades area in southern California; this fire led to loss of life for 12 people and loss of ~7,000 structures, mostly homes, with all of their contents. Similarly, in the same month, fires in other areas of southern California such as Altadena and the San Gabriel mountains devastated those communities, killing at least 19 people and causing the loss of ~9,000 structures. Studies have shown that structures that have been fire-hardened through removal of vegetation from within five feet of the perimeter, or by using non-combustible siding, roofing, and decking materials, are nonetheless susceptible to catching fire when flammable debris collects on the roof and is then ignited by a flying ember. Another study demonstrated that protecting one house against flying embers is only effective if neighboring houses are similarly protected. In other words, if one house catches fire, its neighboring house is also likely to catch fire, regardless of what preventative measures may have been taken. Hence, communities must apply a fire prevention strategy not dissimilar from the concept of achieving “herd immunity” in the human vaccination field.

When fires grow to be as large as these just named, firefighting teams become stretched and cannot reach or tend to all areas needing their attention. Hence, homeowners cannot rely upon firefighters to save their home—effective firefighting may instead take the form of systems installed on the property. Furthermore, since firefighters may require the additional volume and/or pressure from the municipal water supply and may therefore shut off water supply to certain houses, homeowners cannot rely upon the availability of municipal water. An effective firefighting system installed on the property should therefore be self-contained and independent of such services. For example, in the Palisades Fire, many homeowners attempted to use a garden hose connected to municipal water supply to keep the roof of their homes wet; however, the water supply was cut off in their neighborhood so that firefighters in adjacent neighborhoods had the pressure needed for their efforts there.

Similarly, wildfires often ignite wooden utility poles that carry electricity to homes leading to disruptions in electrical power supply. Therefore, an effective firefighting system that homeowners rely upon to save their home during a wildfire must be self-contained and independent of municipal power supply to protect the structure before first-responders arrive.

### SUMMARY

The present application provides descriptions of self-contained systems and related methods for reducing the risk of damage to a structure during a wildfire. Each system provides a method for the generation and distribution of a fire-retardant, such as PHOS-CHEK® WD-881, available commercially from Perimeter Solutions, Clayton, Missouri, United States, or another Class A firefighting foam.

The value of foam-based firefighting agents is well understood. This arises primarily from the considerable advantages that foam provides over water in the ability to extinguish an existing fire in “direct-attack,” or, more relevant to the subject of the present disclosure, for application of a firefighting agent when a structure is under threat of fire or wildfire to suppress the likelihood of the structure igniting. These include, but are not limited to: reduction of the surface tension of the water, leading to better saturation of the fuel; creating a barrier to the atmospheric oxygen required for ignition; high expansion ratio, enabling smaller amounts of water to be used per square foot of surface to be protected; and ability to spread rapidly over a surface. Research has shown that the use of foam-based fire suppression materials is most successful when distribution of the material is especially directed to regions or “zones” where debris may accumulate. For example, debris may include dead leaves, pine needles, and other plant material. In this context, zones for treatment may include, but are not limited to:
A) Rain gutters, where the drip edge often exposes wood underlayment to ignition from burning leaves within the gutter.
B) Flashing around a chimney, or other roof penetration such as an air vent, where debris may collect such that when burning, embers may enter the attic.
C) Where solar panels are installed on the roof, which often collect debris that may cause a roof fire.
D) Wooden decks and deck railings, where they abut the home, itself.

In some embodiments, the system is based upon the use of compressed-air to generate and distribute firefighting foam across the structure (hereinafter referred to as an “air-based system”), with special emphasis on those zones that are most likely to collect debris or are otherwise most sensitive to ignition, such as a wooden deck.

In some embodiments, the system is based upon the use of pumped water, from a self-contained supply, to generate and distribute firefighting foam across the structure (hereinafter referred to as “water-based system”), with special emphasis on those zones that are most likely to collect debris or are otherwise most sensitive to ignition, such as a wooden deck.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The disclosure can be better understood with reference to the following drawings and descriptions. The components in the figures are not necessarily to scale, emphasis being placed upon illustrating the principles of the disclosure.

FIG. 1 shows a schematic of an exemplary two-story house.

FIG. 2 shows an air-based system in accordance with embodiments of the present disclosure.

FIG. 3 shows a water-based system in accordance with embodiments of the present disclosure.

FIG. 4 shows a power/control module in accordance with embodiments of the present disclosure.

FIG. 5 shows a logic diagram in accordance with embodiments of the present disclosure.

FIGS. 6a-6d depict a scale model of a structure.

FIGS. 7a-7d depict a scale model of a structure equipped with a system in accordance with embodiments of the present disclosure.

### DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

Throughout this disclosure, various aspects may be presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions, or other units of measure, refers to the dimension, or other unit of measure, plus or minus 10%.

The disclosed embodiments relate to systems, devices, and methods that can be used in an assembly that would be customized to the specific structure (house, condominium, townhouse, multi-family housing unit, etc.) into which the system is installed in order to provide resistance to wildfire. To accomplish this customization, the disclosure is designed in a modular fashion. For example, the disclosed embodiments can be used with a customizable number of modules, as described below, to accomplish the distribution of fire-retardant, such as a fire-fighting Class A foam product, to specific sections (zones) of the structure in a controlled manner. Hence, the system would be customized for each structure to be protected.

In some examples, the disclosed foam-distribution system can allow for treatment of a structure well ahead of the imminent appearance of embers from an approaching wildfire. In other examples, the foam-distribution system can allow for treatment of a structure that already is aflame from embers, which may be driven to the relevant structure by wind. Under such circumstances, the foam-distribution system can be used to direct all available resources to only those zones that already are aflame.

In some examples, the disclosed foam-distribution system can allow for treatment of fire-susceptible structures adjacent to or attached to the main structure, such as a wooden deck.

As used herein, the term “foam” may include any of a variety of commercially available foam fire-retardants, such as Class A foam fire-retardants and Class B foam fire-retardants. Class A foams are used to extinguish “Class A” materials, such as wood, paper, brush, and vegetation, and are most relevant to wildfires and for the prevention, suppression, and extinction of fires on structures. Class B foams are also known as “aqueous film forming foam” (AFFF) and are used to extinguish “Class B” materials, such as gasoline, oil, and other fuels such as jet fuel. Depending on the structure in which the systems described herein are installed, the systems described herein may be equipped to generate either Class A foam or Class B foam. For example, the systems described herein may be installed in a house in a wooded area that may be susceptible to a wildfire and may therefore be equipped with Class A foam. Alternatively, the systems described herein may be installed in a structure on or near, for example, an airport where a fire may be fueled by jet fuel rather than brush or vegetation and may therefore be equipped with Class B foam. The decision to recite exemplary embodiments with a particular type of foam to the exclusion of another is in the interest of brevity only and is not intended to be limiting.

One example of a Class A foam is PHOS-CHEK® WD881, available commercially from Perimeter Solutions, Clayton, Missouri, United States. PHOS-CHEK® is an environmentally safe product that is frequently used by professional fire-fighting teams. The use of fire-fighting foam greatly increases the surface area of water applied to the structure and thus makes the water more effective in resisting ignition of the structure. PHOS-CHEK® has a viscosity of about 41 cP at 75° C., a pH of about 7.5, a density of about 8.55 lbs/US gallon, and a surface tension of about 29.6 dynes/cm² at 0.3%. PHOS-CHEK® WD 881 comprises between 1-5 wt % D-limonene, between 1-5 wt % lauryl alcohol, between 0-5 wt % water, between 10-30 wt % 2-methyl-2,4-pentanediol, and between 60-80 wt % of a non-hazardous alpha-olefin sulfonate solution.

In some embodiments, the systems, devices, and methods include one or more fluid handling devices configured for compressed-air-based foam generation and distribution protocols. In other embodiments, the system may include one or more fluid handling devices configured for pressurized-water-based foam generation and distribution protocols.

As used herein, the term “communicate” or “connect” (e.g., a first component “communicates with” or “is in communication with” a second component) or “compressed air communication” and grammatical variations thereof are used herein to indicate a relationship between two or more components and/or modules. As such, the fact that one component is said to communicate with a second component is not intended to exclude the possibility that additional components may be present between, and/or operatively associated or engaged with, the first and second components.

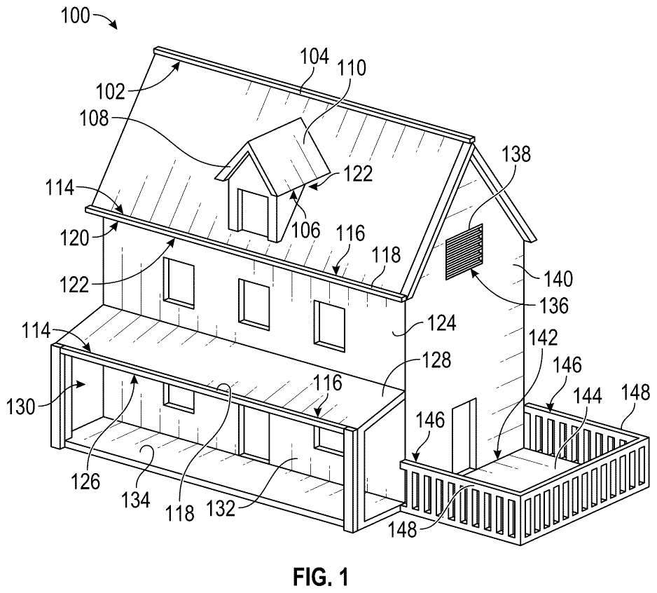

FIG. 1 depicts a simple two-story structure 100 with various “zones” where nozzles from the air-based system or water-based system described herein may be placed. Depending upon the complexity of the structure to be protected, there may be other zones and the decision to depict only those shown in FIG. 1 is in the interest of brevity only and is not intended to be limiting. It is to be understood that zones for foam distribution also may be installed in other portions of the structure not shown in this view. For example, solar panels may be installed onto a portion of the roof that is not visible in FIG. 1 but may nonetheless be a desirable location or zone for the air-based system or water-based system described herein. Similarly, some vents and other roof penetrations are installed into the side of the roof facing the rear of the home for enhanced curb appeal; these may be omitted from FIG. 1 for this reason.

In FIG. 1, the structure 100 may include a zone 102 at the ridge roof vents 104 at the top of the structure 100. Zone 106 includes the soffit 108 under the dormer eaves 110 and extending down onto the siding-roof interface 112. Zone 114 includes the inside edges 116 of the gutters 118, adjacent to the structure 100. Zone 120 includes the roof eaves 122 and extending down onto the second-floor wall 124. Zone 126 includes the roof 128 above the porch 130 and extending down onto the first-floor wall 132 and to the wooden front porch 134, if present. Zone 136 includes gable vents 138 and extending down the end wall siding 140. Zone 142 includes the wooden deck 144, if present, and especially where the wooden deck 144 abuts the structure 100. Zone 146 includes the rails 148 of the wooden deck 144 and especially where they abut the structure 100.

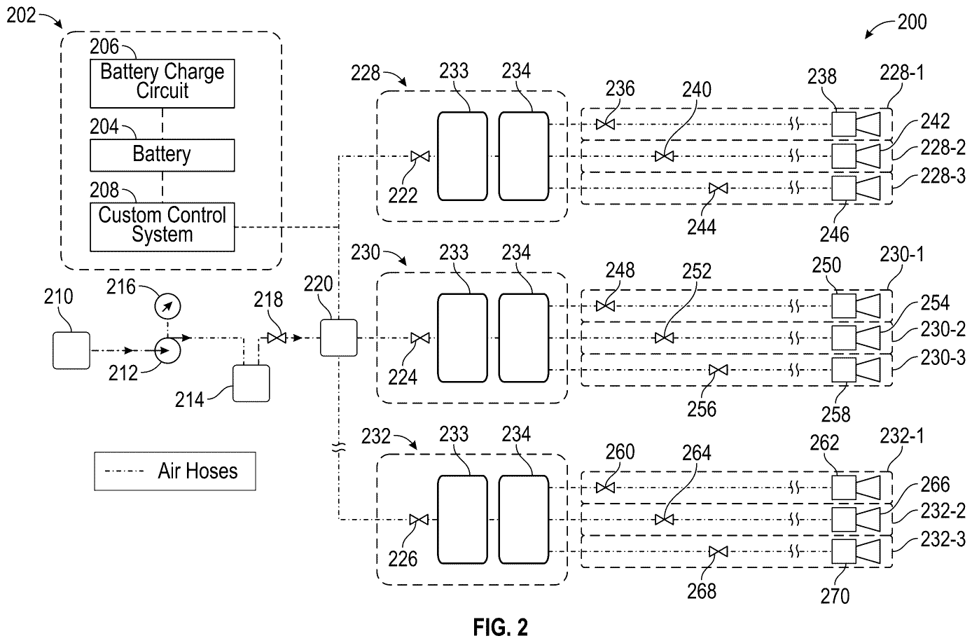

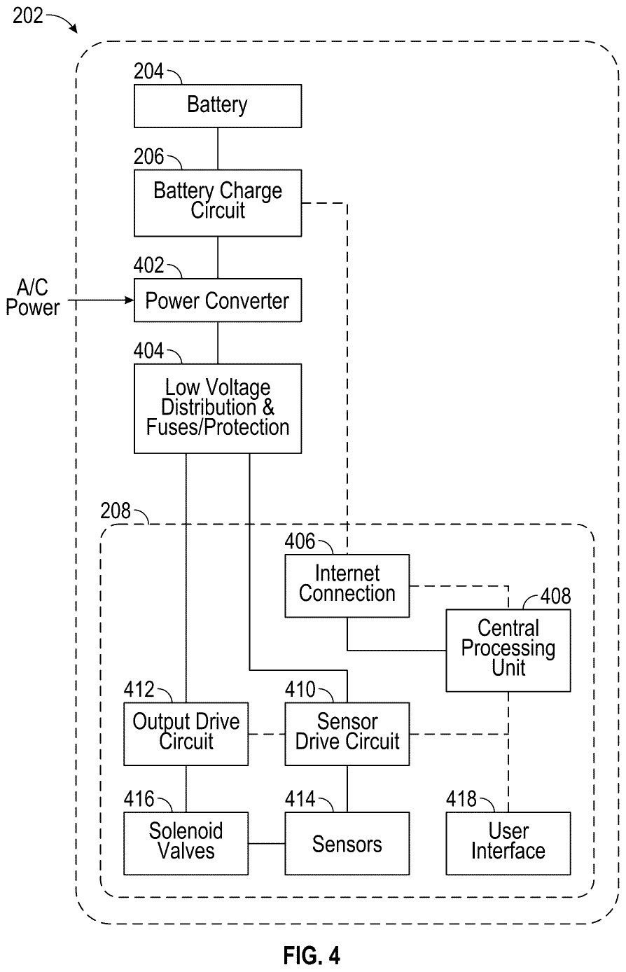

FIG. 2 depicts one embodiment of an air-based system 200 according to embodiments of the present disclosure, with the various functional components of the system connected to each other using air hoses. The system 200 includes a power/control module 202, which will be described in further detail with reference to FIG. 4. The power/control module 202 utilizes a battery 204, which may be an automotive battery, charged by a battery charge circuit 206, which may include a trickle charger for example, to power a custom control system 208 which is communicatively connected to the various solenoid valves and sensors in the system 200.

The system 200 includes an air source 210, which may be the outside air. Air from the air source 210 is compressed by a fluid handling device in the form of a compressor 212, which may be a DC air compressor, such as a low-voltage DC air compressor, optionally battery-operated to ensure the compressor is operable without reliance on municipal grid energy. The compressed air is stored in an expansion air tank 214 and the pressure of the air is monitored by a pressure sensor 216. A first solenoid valve 218, which is normally closed, isolates the air in the expansion air tank 214 from the passive system manifold 220; engaging the system to extinguish or prevent a fire as described herein involved opening the first solenoid valve 218 to permit air to exit the expansion air tank 214 and pass into the system manifold 220.

The system manifold 220 is responsible for diverting flow of air from the expansion air tank 214 to the various modules in the system 200, which modules will subsequently divert the air to the various module zones. This may be effectively achieved by the opening of the module solenoid valves 222, 224, 226 by the power/control module 202, which modules solenoid valves are normally closed. The system 200 is depicted with a first module 228, a second module 230, and an “n^{th}” module 232, representing that the system 200 may include any number of modules. As will be described in further detail below, each module may be responsible for delivering fire-retardant to one or more module zones within the structure to be protected. Thus, depending on the number of zones within the structure, and the location of those zones within the structure, the system 200 may include 2 modules, 3 modules, 4 modules, 5 modules, 6 modules, 7 modules, or more modules, depending on the size, shape, and needs of the structure. It should be understood that the decision to recite a particular number of modules, or to recite only “n” number of modules, is in the interest of brevity only.

The module solenoid valve 222 coupled to the first module 228 may be configured to open if one of the module zones coupled to the first module 228 is identified by the power/control module 202 as a target for the fire-retardant. Similarly, the module solenoid valve 224 coupled to the second module 230 may be configured to open if one of the module zones coupled to the second module 230 is identified by the power/control modules as a target for the fire-retardant. The module solenoid valve(s) 226 coupled to one of the n^{th} modules 232 may be configured to open if one of the module zones coupled to the n^{th} module is identified by the power/control modules as a target for the fire-retardant. Furthermore, one or more of the module solenoid valves 222, 224, 226 may be configured to be opened simultaneously depending on the needs of the system 200.

Each of the first module 228, the second module 230, and the n^{th} module 232 may include a liquid dispensing tank 233 with a solution of a fire-retardant. The fire-retardant may be, for example, PHOS-CHEK® or another Class A firefighting foam, or another suitable fire-retardant solution.

The first module 228 in the system 200 is depicted as being functionally connected to three zones: 228-1, 228-2, and 228-3. Zone 228-1 includes a module zone solenoid valve 236 and one or more nozzles 238; zone 228-2 includes a module zone solenoid valve 240 and one or more nozzles 242; and zone 228-3 includes a module zone solenoid valve 244 and one or more nozzles 246. Similarly, the second module 230 in the system 200 is depicted as being functionally connected to three zones: 230-1, 230-2, and 230-3. Zone 230-1 includes a module zone solenoid valve 248 and one or more nozzles 250; zo30-2 includes a module zone solenoid valve 252 and one or more nozzles 254; and zone 230-3 includes a module zone solenoid valve 256 and one or more nozzles 258. The n^{th} module 232 in the system 200 is depicted as being functionally connected to three zones: 232-1, 232-2, and 232-3. Zone 232-1 includes a module zone solenoid valve 260 and one or more nozzles 262; zone 232-2 includes a module zone solenoid valve 264 and one or more nozzles 266; and zone 232-3 includes a module zone solenoid valve 268 and one or more nozzles 270.

Each of the zones depicted in FIG. 2 may correspond to one or more areas in a structure that may be targeted by the system for fire extinguishing, fire suppression, or fire prevention. For example, zone 228-1 may correspond to the ridge vent(s) at the top of the house or other areas on the top of the house. Zone 228-2 may correspond to the dormer eaves and extending onto the shingle-siding interface. Zone 228-3 may correspond to the roof eaves and extending down along the walls. Thus, the first module 228 in the system 200 may be configured to be engaged by the system 200 to suppress or prevent a fire or the threat of a fire on the roof of a structure. To accomplish this, the power/control module 202 may open the first solenoid valve 218, the module solenoid valve 222, and one or more of the module zone solenoid valves 236, 240, 244, thereby permitting the air from the expansion tank 214 to pass through the system manifold 220 and push the solution of fire-retardant within the liquid dispensing tank 233 in the first module 228 through the module manifold 234 in the first module 228 and out of the nozzles 238, 242, 246 (depending on which module zone solenoid valves are opened). Beginning in the liquid-dispensing tank 233 and continuing upon ejection from the nozzles 238, 242, 246, the solution of fire-retardant rapidly expands into a foam, effecting the fire suppression or prevention of the present invention.

In FIG. 2, zone 230-1 may correspond, for example, to the gable vents of a house and extending down the side of the house siding. Zone 230-2 may correspond to the gutters at the drip edge. Zone 230-3 may correspond to the deck railings of a house and extending onto the wooden deck, if present. Thus, the second module 230 in the system 200 may be configured to be engaged by the system 200 to suppress or prevent a fire or the threat of a fire along the sides of a house and extending to the deck of the house. To accomplish this, the power/control module 202 may open the first solenoid valve 218, the module solenoid valve 224, and one or more of the module zone solenoid valves 248, 252, 256, thereby permitting the air from the expansion tank 214 to pass through the system manifold 220 and push the solution of fire-retardant within the liquid dispensing tank 233 in the second module 230 through the module manifold 234 in the second module 230 and out of the nozzles 250, 254, 258 (depending on which module zone solenoid valves are opened). Beginning in the liquid-dispensing tank 233 and continuing upon ejection from the nozzles 250, 254, 258, the solution of fire-retardant rapidly expands into a foam, effecting the fire suppression or prevention of the present invention.

In FIG. 2, zone 232-1 may correspond, for example, to the flashing of the chimney or other roof vents. Zone 232-2 may correspond to solar panels and/or where solar panels attach to the roof, if present. Zone 232-3 may correspond to other roof penetrations, including vents. Thus, the n^{th} module(s) 232 in the system 200 may be configured to be engaged by the system 200 to suppress or prevent a fire or the threat of a fire along any other portion of the house where such fire suppression or prevention is needed or desired. To accomplish this, the power/control module 202 may open the first solenoid valve 218, the module solenoid valve(s) 226, and one or more of the module zone solenoid valves 260, 264, 268, thereby permitting the air from the expansion tank 214 to pass through the system manifold 220 and push the solution of fire-retardant within the liquid dispensing tank 233 in the n^{th} module 232 through the module manifold 234 in the n^{th} module 232 and out of the nozzles 262, 266, 270 (depending on which module zone solenoid valves are opened). Beginning in the liquid dispensing tank 233 and continuing upon ejection from the nozzles 262, 266, 270, the solution of fire-retardant rapidly expands into a foam, effecting the fire suppression or prevention of the present invention.

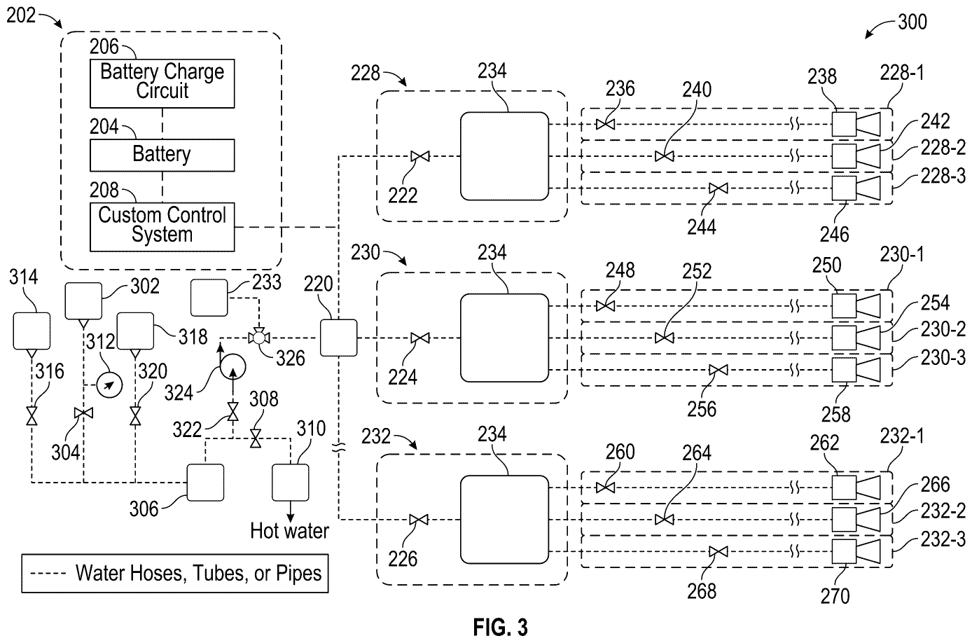

FIG. 3 shows a water-based system 300 according to embodiments of the present disclosure. Like components as those depicted in FIG. 2 are depicted with like numbers and operate in a similar manner.

The system 300 depicted in FIG. 3, when inactive, may present to the homeowner as their hot water source. Municipal or well water 302 is supplied through a normally-open solenoid valve 304. This water fills and is stored in a water tank 306 where it freely passes through normally-open solenoid valve 308 to the hot water heater 310 where it may then be used by the homeowner as hot water. The water pressure of the municipal or well water 302 may be measured by a pressure sensor 312 so that, as described in further detail below, the water source for the water-based system 300 may be switched to an alternative if the municipal or well water 302 is deactivated by the city for, for example, firefighting purposes.

The system 300 includes, if present, an input means for pool water 314 which may be supplied to the water tank 306 via a normally closed solenoid valve 316. The system 300 further includes an input means for outside air 318 which may be supplied to the water tank 306 via a normally closed solenoid valve 320. The outside air may be used in this context to avoid the generation of a vacuum by withdrawal of water from the water tank 306 when the system is active. Thus, the system 300 may effectively prevent, suppress, or extinguish fire regardless of the availability of municipal water supply.

Upon determining that fire prevention, suppression, or extinction is desired, the power/control module 202 may close the normally-open solenoid valve 308 and open normally-closed solenoid valve 322, thereby redirecting water from water tank 306 to a fluid handling device in the form of a pump 324, which may be a DC pump, such as a low-voltage DC pump, optionally battery-operated to ensure the pump is operable without reliance on municipal grid energy. The water is pumped by the pump 324 to a valve 326, which may be a venturi valve, such as a venturi proportional mixing valve. The valve 326 mixes the water with fire-retardant concentrate from the liquid dispensing tank 233, which may contain, for example, a Class A fire-retardant concentrate such as PHOS-CHEK® or another suitable fire-retardant solution.

Upon mixing the water with the fire-retardant concentrate, the fire-retardant may be in a compressed foam form and may be transferred along water hoses to the system manifold 220. As described with respect to FIG. 2, the power/control module 202 may open one or more of the module solenoid valves 222, 224, 226 depending on which location(s) on the structure are targeted for fire prevention, suppression, or extinction. If, for example, the module solenoid valve 222 is opened so that the first module 228 is engaged, a passive module manifold 234 in the first module 228 receives at least a portion of the fire-retardant from the system manifold 220, where it is then redirected to one or more of the module zones 228-1, 228-2, 228-3 depending on which one or ones of the module zone solenoid valves 236, 240, 244 are opened by the power/control module 202.

If, for example, the module solenoid valve 224 is opened so that the second module 230 is engaged, a passive module manifold 234 in the second module 230 receives at least a portion of the fire-retardant from the system manifold 220, where it is then redirected to one or more of the module zones 230-1, 230-2, 230-3 depending on which one or ones of the module zone solenoid valves 248, 252, 256 are opened by the power/control module 202.

If, for example, the module solenoid valve 226 is opened so that the n^{th} module 232 is engaged, an n^{th} passive module manifold 234 in the n^{th} module receives at least a portion of the fire-retardant from the system manifold 220, where it is then redirected to one or more of the module zones 232-1, 232-2, 232-3 depending on which one or ones of the module zone solenoid valves 260, 264, 268 are opened by the power/control module 202.

The zones depicted in FIGS. 2 and 3 and described above may vary in their size and shape and may therefore require different numbers of nozzles in order to achieve the desired level of fire prevention, suppression, and/or extinction. As such, the one or more nozzles 238 may refer to one nozzle, two nozzles, three nozzles, five nozzles, ten nozzles, twenty nozzles, more nozzles, or any number of nozzles therebetween depending on the needs of the system and the shape and size of the zone 228-1. Similarly, the one or more nozzles 242 may refer to one nozzle, two nozzles, three nozzles, five nozzles, ten nozzles, twenty nozzles, more nozzles, or any number of nozzles therebetween depending on the needs of the system and the shape and size of the zone 228-2. The one or more nozzles 246 may refer to one nozzle, two nozzles, three nozzles, five nozzles, ten nozzles, twenty nozzles, more nozzles, or any number of nozzles therebetween depending on the needs of the system and the shape and size of the zone 228-3.

The one or more nozzles 250 may refer to one nozzle, two nozzles, three nozzles, five nozzles, ten nozzles, twenty nozzles, more nozzles, or any number of nozzles therebetween depending on the needs of the system and the shape and size of the zone 230-1. The one or more nozzles 254 may refer to one nozzle, two nozzles, three nozzles, five nozzles, ten nozzles, twenty nozzles, more nozzles, or any number of nozzles therebetween depending on the needs of the system and the shape and size of the zone 230-2. The one or more nozzles 258 may refer to one nozzle, two nozzles, three nozzles, five nozzles, ten nozzles, twenty nozzles, more nozzles, or any number of nozzles therebetween depending on the needs of the system and the shape and size of the zone 230-3.

The one or more nozzles 262 may refer to one nozzle, two nozzles, three nozzles, five nozzles, ten nozzles, twenty nozzles, more nozzles, or any number of nozzles therebetween depending on the needs of the system and the shape and size of the zone 232-1. The one or more nozzles 266 may refer to one nozzle, two nozzles, three nozzles, five nozzles, ten nozzles, twenty nozzles, more nozzles, or any number of nozzles therebetween depending on the needs of the system and the shape and size of the zone 232-2. The one or more nozzles 270 may refer to one nozzle, two nozzles, three nozzles, five nozzles, ten nozzles, twenty nozzles, more nozzles, or any number of nozzles therebetween depending on the needs of the system and the shape and size of the zone 232-3.

FIG. 4 shows a power/control system 202 and its devices according to embodiments of the present disclosure. Like structures as those depicted in FIGS. 2 and 3 are depicted with like numbers.

The power/control system 202 includes a battery 204, a battery charge circuit 206, which may include a trickle charger, and a power converter 402. The power converter 402 accepts A/C power from an A/C power source to ensure the battery is charged. Electrical power is supplied to low voltage distribution systems 404, which may include fuses and other voltage protection means. The power/control system 202 also includes a custom control system 208 with a number of subcomponents. The custom control system 208 may include an internet connection 406, which may be a wired internet connection, a wireless internet connection, or a combination of both wireless and wired internet connections depending on the specific components and the shape and size of the structure in which the system is installed, and which enables communication between the various components of the power/control system 202 and the components of the systems described herein. The internet connection 406 enables communication between the central processing unit 408, the sensor drive circuit 410, and the output drive circuit 412.

The central processing unit 408 may contain instructions for interacting with the various solenoid valves and other components in the system in order to dispense fire-retardant. For example, a user may interact with a user interface 418 in response to “red flag conditions” to engage the system to preemptively dispense fire-retardant on one or more zones of a structure. Upon interaction with the user interface 418, an instruction may be sent to the central processing unit 408, and the central processing unit 408 may then instruct the solenoid valves in the system to open or close according to the particular instructions being sent and the architecture of the system that is installed.

The sensor drive circuit 410 enables communication and control over the various sensors 414 in the systems described herein. For example, the system 200 depicted in FIG. 2 includes a pressure sensor 216, and the system 300 depicted in FIG. 3 depicts pressure sensor 312. These and other sensors that may be reasonably inferred by the disclosure may be communicated with and controlled by the sensor drive circuit 410 as depicted, for example, in FIG. 4.

The output drive circuit 412 enables communication and control over the various solenoid valves 416 in the system described herein. Each of system 200 depicted in FIG. 2 and system 300 depicted in FIG. 3 include a number of solenoid valves which, when opened or closed, control the flow of fire-retardant to various zones within the structure. Thus, by enabling communication and control between the sensors and valves in these and other exemplary systems, the power/control module 202 enables the fire prevention, suppression, and/or extinction of the present invention.

In some embodiments, the system may require more than one air-based system depending on the size of the structure. In some embodiments, the system may require more than one water-based system depending on the size of the structure. In these embodiments, more than one power and control system may be required.

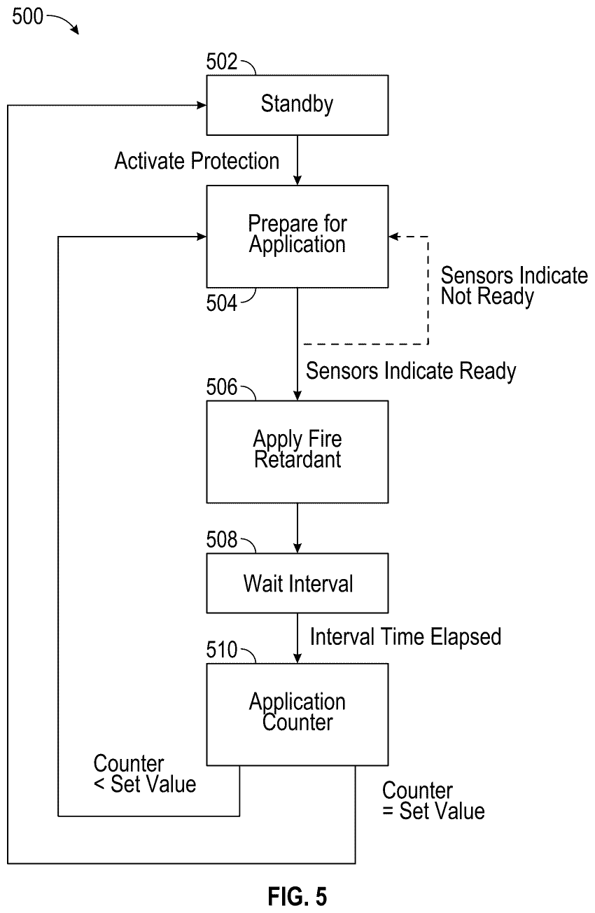

In some embodiments, the power/control module engages the systems described herein by implementing certain logic in one or more zones within the structure. An exemplary logic diagram 500 is depicted in FIG. 5. In step 502, the power/control module considers the zone, which may correspond to any one of the zones depicted in, for example, FIG. 2 or 3, to be in a “standby” state. When protection is activated, such as by a homeowner in anticipation of a wildfire, the logic progresses to step 504 in which the zone is changed from a standby state to a “Preparation” state whereby the zone is preparing for application of the fire retardant. During the preparation step 504, various sensors in the system are checked to determine if the system is prepared for deployment of the fire retardant. When the power/control module determines that a sufficient number of sensors indicate that the system is “ready,” the logic may proceed to the next step. As used herein, a “sufficient” number of sensors may be all of the sensors in the installed system, or it may be fewer than all of the sensors in the installed system. For example, since the logic diagram 500 may be implemented for each individual zone, only those sensors associated with that zone may be evaluated as part of step 504. In some embodiments, the homeowner may engage the system with the desire to deploy fire retardant across multiple zones and the logic may therefore wait for a “ready” state from the sensors in each zone before deploying any fire retardant because of the close proximity of the zones. In some embodiments, the logic in each zone immediately progresses to the next step upon determining that the sensors in that zone are “ready.”

In step 506 of the logic diagram 500, after the sensors have indicated that the system is ready, fire retardant is applied to the structure. In some embodiments, as described herein, this may include compressing air using an air compressor and driving liquid from one or more liquid storage tanks through one or more nozzles. In some embodiments, the nozzles are foam-aspirating nozzles so that step 506 of the logic diagram 500 involves applying foam-based fire retardant to the zone. In some embodiments, step 506 involves applying the fire retardant for a set duration. The set duration may be predetermined based on the geometry or size of the zone, or it may be predetermined based on the size of the volume of the liquid dispensing tank that is installed in the system.

After the fire retardant has been applied in step 506 of the logic diagram 500, the system idles for a predetermined “wait” interval in step 508. The wait interval may be set based on a predetermined duration before a subsequent application of fire retardant is applied to the structure. For example, if the system is engaged by a homeowner prior to an evacuation, the wait interval may be a predetermined period so that the structure may receive multiple applications of fire retardant in case first-responders are unable to reach the structure. After the wait interval has elapsed, an Application Counter is indexed in step 510 so that the system may continue with the logic with an accurate understanding of the number of fire retardant applications that have been deployed within the zone that the logic diagram 500 is controlling.

Finally, the logic proceeds to compare the application counter with a set value in order to determine if the desired number of fire retardant applications has been applied. If the application counter is less than the set value, the logic is cycled to step 504 wherein the system returns to the “preparation” step. If the application counter is equal to the set value, the logic is cycled to step 502 wherein the system returns to a “standby” state.

Methods for distributing a fire-retardant solution to portions of a structure are also provided herein. In one aspect, the methods include providing and operating one or more of the systems described herein. In some embodiments, the methods include expelling fluid from a fluid storage tank using a fluid handling device. For example, the fluid may be air, the fluid storage tank may be an expansion air tank, and the fluid handling device may be an air compressor, as described herein. As another example, the fluid may be water, the fluid storage tank may be a water flow-through tank, and the fluid handling device may be a pump.

In some embodiments, the methods include mixing the fluid from the fluid storage tank with liquid from one or more liquid dispensing tanks to generate a fire-retardant solution. For example, the liquid in the one or more liquid dispensing tanks may be a fire-retardant concentrate that is configured to produce a fire-retardant solution upon mixing with water. As another example, the liquid in the one or more liquid dispensing tanks may be a fire-retardant solution that is configured to be driven out of the liquid dispensing tank by air.

In some embodiments, the methods include distributing, for each module in one or more modules, the fire-retardant solution to one or more module zones using a module manifold. Upon mixing the fluid from the fluid storage tank with liquid from the one or more liquid dispensing tanks to generate the fire-retardant solution, this fire-retardant solution may then be distributed to various module zones by a module manifold as described herein. In some embodiments, the methods include dispensing using at least one nozzle, for each module zone in the one or more module zones in each module in the one or more modules, at least a portion of the fire-retardant solution onto at least one surface of the structure. In other words, the methods may include operating systems that have multiple modules, and each module may have multiple module zones, and each module zone may have multiple nozzles such that the methods include dispensing the fire-retardant solution through one or more of the nozzles in each of the zones, in each of the modules.

In some embodiments, the methods further include receiving instructions from a user using a user interface, communicating the instructions to a central processing unit, identifying, based on the instructions, a plurality of solenoid valves to be actuated; and actuating the plurality of solenoid valves. The user interface may be a control panel installed in the user's house. When “red flag conditions” or other conditions exist such that the user desires to engage the system to prevent or suppress ignition of their structure in the event of a fire or wildfire, the user may utilize the user interface to send instructions to the central processing unit. If, for example, the user identifies a specific zone or series of zones to be treated (or all of the zones in the structure), the central processing unit will identify which solenoid valves correspond to the zones selected by the user and will then send an instruction to actuate those solenoid valves. As described herein, this enables the expelling of fluid from the fluid storage tank, mixing of fluid with liquid from the liquid dispensing tank, distribution of fire-retardant solution to module zones, and dispensation of fire-retardant solution using nozzles. In some embodiments, dispensing the portion of the fire-retardant solution includes dispensing through a foam-aspirating nozzle.

In some embodiments, the methods include charging a battery and, upon detecting a loss of municipal electrical power, transitioning to battery power. As described herein, the battery may be an automotive battery that is charged using a trickle charger so that it may be utilized at any time.

In some embodiments, expelling the fluid includes compressing, using an air compressor, atmospheric air into an expansion air tank and mixing atmospheric air from the expansion air tank with a fire-retardant solution in each liquid dispensing tank in the one or more liquid dispensing tanks to drive the fire-retardant solution from each liquid dispensing tank to each module manifold in the one or more modules. In some embodiments, the methods include distributing the atmospheric air from the expansion air tank to each module in the one or more modules using a system manifold. This air may then interact with the one or more liquid dispensing tanks to effect dispersion of the fire-retardant solution within as foam.

In other words, there may be a liquid dispensing tank associated with each module, and each liquid dispensing tank may include ready-to-dispense fire-retardant solution such that driving the fire-retardant solution from the liquid dispensing tank with the compressed air and through the module manifolds and nozzles effects dispersion of the fire-retardant onto the structure.

In some embodiments, expelling the fluid includes pumping, using a pump, water from a water flow-through tank and mixing the fluid from the fluid storage tank with liquid from one or more liquid dispensing tanks comprising mixing water from the water flow-through tank with a fire-retardant concentrate in a liquid dispensing tank using a venturi proportional mixing valve to generate the fire-retardant solution. In some embodiments, the methods include distributing the fire-retardant solution from the venturi proportional mixing valve to each module manifold in the one or more modules using a system manifold.

In other words, there may be a liquid dispensing tank having a fire-retardant concentrate configured to mix with water from the water flow-through tank to generate the fire-retardant solution. This solution may then be distributed to the various modules using the system manifold.

### Example: Scale Model

Two identical scale models of a structure were constructed, each consisting of exposed wooden walls and conventional shingle roofs. A system as described herein was installed in one of the structures. The system was equipped with PHOS-CHEK® WD 881 fire retardant concentrate, available commercially from Perimeter Solutions, Clayton, Missouri, United States. Flammable debris in the form of dry leaves were scattered on the roofs of each model. The flammable debris were then ignited and allowed to burn so that the effect on the underlying structure may be observed.

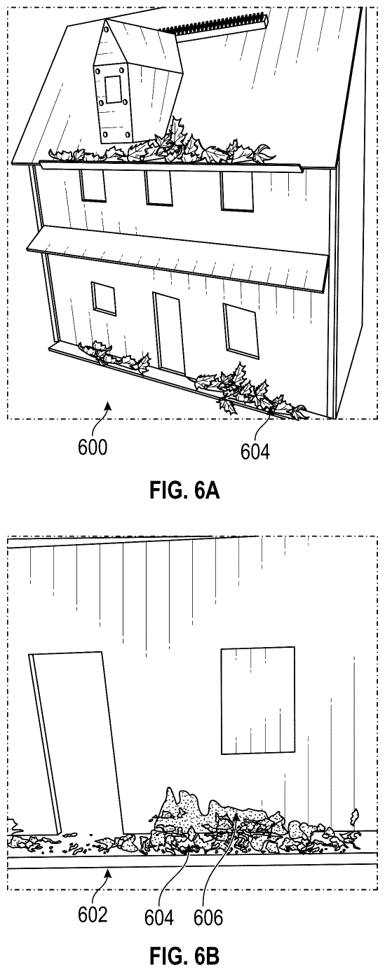

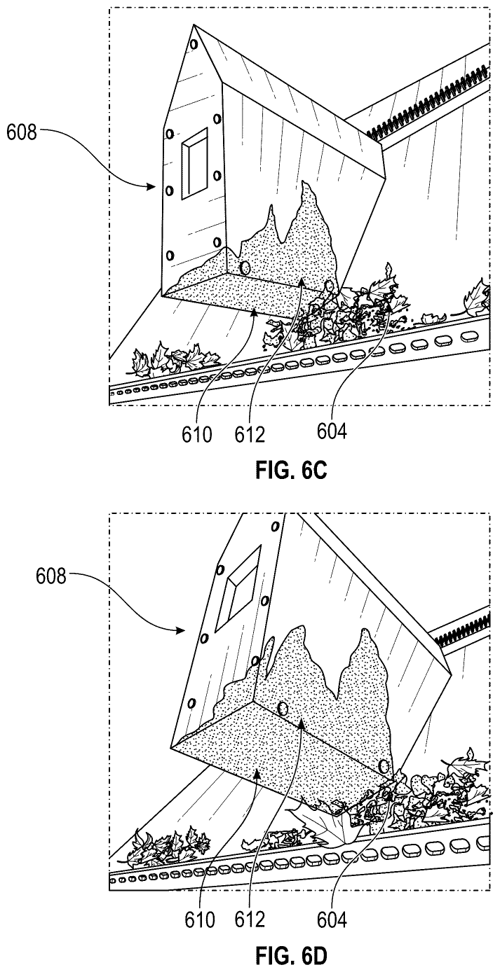

FIGS. 6a-6d depict the model 600 without the system as described herein installed. FIG. 6a depicts the model 600 prior to any ignition. FIG. 6b depicts the base 602 of the model 600 in which flammable debris 604 has been burned and consumed by fire, damaging the siding 606 of the structure 600. FIGS. 6c and 6d depict the dormer 608 of the structure in which flammable debris 604 has been burned and consumed by fire, damaging the underside 610 and siding 612 of the dormer 608.

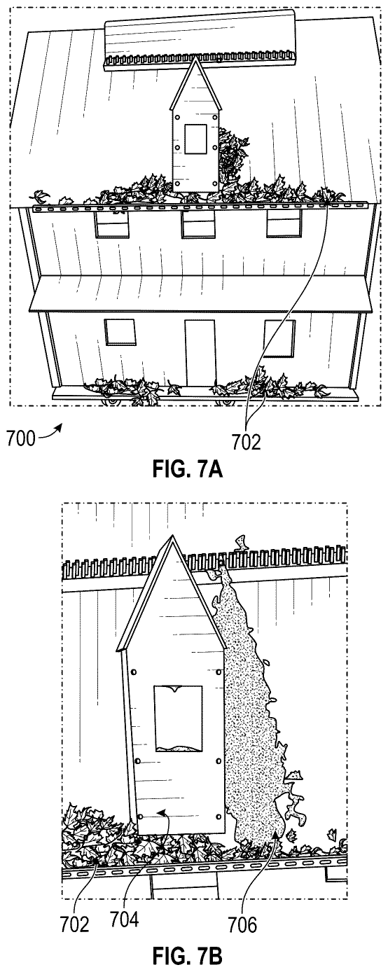

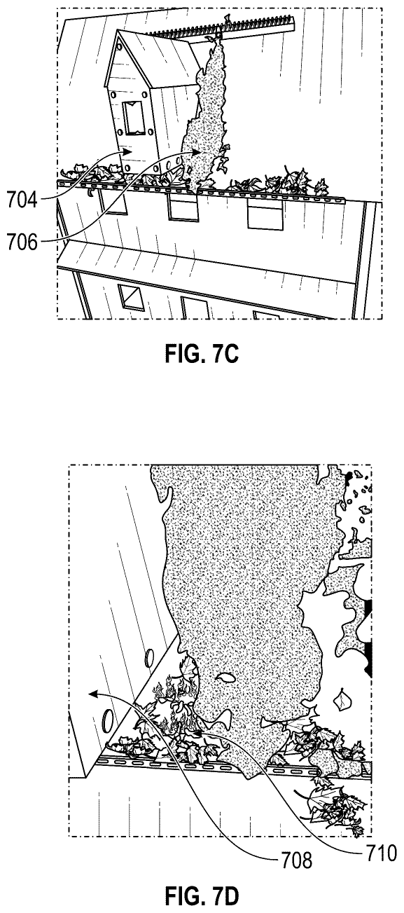

FIGS. 7a-7d depict the model 700 with the system as described herein installed. FIG. 7a depicts the model 700 prior to any ignition and prior to the engagement of the system, although flammable debris 702 is present. FIG. 7b depicts the dormer 704 of the model 700 in which the system has been engaged to deploy fire retardant 706 and after ignition of the flammable debris 702. FIG. 7c depicts another view of the dormer 704 and fire retardant 706. FIG. 7d depicts a close-up view of the siding 708 of the dormer 704 in which burned flammable debris 710 is visible. Despite igniting the flammable debris, the fire retardant suppressed the spread of the fire and prevented any visible damage to the structure.

Though the disclosed examples include particular arrangements of a number of parts, components, features, and aspects, the disclosure is not limited to only those examples or arrangements shown. Any one or more of the parts, components, features, and aspects of the disclosure may be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single element, but the corresponding description should be read to include embodiments of two or more elements. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A system for distribution of a fire-retardant solution to portions of a structure, comprising:
a battery;
a fluid handling device;
a fluid storage tank, wherein the fluid handling device is configured to expel fluid from the fluid storage tank;
one or more liquid dispensing tanks fluidicly coupled to the fluid storage tank, wherein fluid from the fluid storage tank is configured to mix with liquid from the one or more liquid dispensing tanks to generate a fire-retardant solution; and
one or more modules, each of the one or more modules fluidicly coupled to a system manifold, each of the one or more modules comprising:
a module manifold configured to distribute the fire-retardant solution to one or more module zones, each of the one or more modules zones comprising:
one or more nozzles configured to dispense at least a portion of the fire-retardant solution onto at least one surface of the structure;
wherein the system manifold is configured to distribute fluid from the fluid storage tank to the one or more modules.

2. The system of claim 1, further comprising a power and control system, the power and control system comprising:
the battery;
a battery charging circuit;
a central processing unit in communication with the fluid handling device;
a user interface in communication with the central processing unit;
an output drive circuit in communication with the central processing unit configured to actuate a plurality of solenoid valves upon receiving an instruction from the central processing unit; and
a sensor drive circuit in communication with the central processing unit configured to communicate with one or more sensors and transmit data from the one or more sensors to the central processing unit.

3. The system of claim 2, wherein the plurality of solenoid valves comprises:
a first normally-closed solenoid valve disposed between the fluid storage tank and the system manifold,
one or more normally-closed module solenoid valves, each module solenoid valve disposed between one of the one or more modules and the system manifold, and
one or more normally-closed module zone solenoid valves, each module zone solenoid valve disposed between one of the module manifolds and at least one of the one or more nozzles.

4. The system of claim 1, wherein the fire-retardant is a Class-A firefighting foam.

5. The system of claim 4, wherein the Class-A firefighting foam comprises:
1-5 wt % D-limonene,
1-5 wt % lauryl alcohol,
0-5 wt % water, if present,
10-30 wt % 2-methyl-2,4-pentanediol, and
60-80 wt % of a non-hazardous alpha-olefin sulfonate solution.

6. The system of claim 1, wherein the fire-retardant is a Class-B firefighting foam.

7. The system of claim 1, wherein the battery is an automotive battery.

8. The system of claim 1, wherein each of the one or more nozzles are configured as a foam-aspirating nozzle.

9. The system of claim 1, wherein each of the one or more modules is associated with one liquid dispensing tank in the one or more liquid dispensing tanks.

10. The system of claim 1, wherein each liquid dispensing tank in the one or more liquid dispensing tanks has a volume that is determined based on a size of a surface onto which the liquid dispensing tank is intended to dispense the fire-retardant solution.

11. The system of claim 1, wherein the fluid handling device is an air compressor and the fluid storage tank is an expansion air tank,
wherein the air compressor is configured to compress atmospheric air into the expansion air tank,
wherein each module in the one or more modules is associated with one liquid dispensing tank in the one or more liquid dispensing tanks,
wherein the liquid stored in each liquid dispensing tank in the one or more liquid dispensing tanks is a fire-retardant solution, and
wherein the system manifold is configured to distribute air from the expansion air tank to each liquid dispensing tank in the one or more liquid dispensing tanks to drive the fire-retardant solution from the liquid dispensing tank and through the associated module manifold.

12. The system of claim 1, wherein the fluid handling device is a pump and the fluid storage tank is a water flow-through tank,
wherein the water-flowthrough tank is configured to be filled with water from a water source,
wherein the pump is configured to draw water out of the water flow-through tank and deliver the water to a venturi proportional mixing valve,
wherein the liquid stored in the one or more liquid dispensing tanks is a fire-retardant concentrate,
wherein the one or more liquid dispensing tanks is configured to deliver the fire-retardant concentrate to the venturi proportional mixing valve to mix with the water to generate the fire-retardant solution, and
wherein the system manifold is configured to distribute the fire-retardant solution from the venturi proportional mixing valve to each module manifold in the one or more modules.

13. The system of claim 1, wherein the system is configured to distribute the fire-retardant solution to the structure without reliance on municipal water or electricity.

14. A method of distributing a fire-retardant solution to portions of a structure, the method comprising:
expelling fluid from a fluid storage tank using a fluid handling device;
mixing the fluid from the fluid storage tank with liquid from one or more liquid dispensing tanks to generate a fire-retardant solution;
distributing, for each module in one or more modules, the fire-retardant solution to one or more module zones using a module manifold;
dispensing using at least one nozzle, for each module zone in the one or more module zones in each module in the one or more modules, at least a portion of the fire-retardant solution onto at least one surface of the structure.

15. The method of claim 14, further comprising the steps of:
receiving instructions from a user using a user interface;
communicating the instructions to a central processing unit;
identifying, based on the instructions, a plurality of solenoid valves to be actuated; and
actuating the plurality of solenoid valves.

16. The method of claim 14, further comprising the steps of:
charging a battery, and
upon detecting a loss of municipal electrical power, transitioning to battery power.

17. The method of claim 14, wherein dispensing the portion of the fire-retardant solution comprises dispensing through a foam-aspirating nozzle.

18. The method of claim 14,
wherein expelling the fluid comprises compressing, using an air compressor, atmospheric air into an expansion air tank,
wherein mixing the fluid from the fluid storage tank with liquid from one or more liquid dispensing tanks comprises mixing atmospheric air from the expansion air tank with a fire-retardant solution in each liquid dispensing tank in the one or more liquid dispensing tanks to drive the fire-retardant solution from each liquid dispensing tank to each module manifold in the one or more modules, and
wherein the method further comprises:
distributing the atmospheric air from the expansion air tank to each module in the one or more modules using a system manifold.

19. The method of claim 14,
wherein expelling the fluid comprises pumping, using a pump, water from a water flow-through tank,
wherein mixing the fluid from the fluid storage tank with liquid from one or more liquid dispensing tanks comprising mixing water from the water flow-through tank with a fire-retardant concentrate in a liquid dispensing tank using a venturi proportional mixing valve to generate the fire-retardant solution, and
wherein the method further comprises:
distributing the fire-retardant solution from the venturi proportional mixing valve to each module manifold in the one or more modules using a system manifold.

20. The method of claim 14, wherein the method may be performed without reliance on municipal water or electricity.
